(19) United States
(12) Patent Application Publication
(10) Pub. No.: US 2019/0386995 A1
(43) Pub. Date: Dec. 19, 2019

(54) APPARATUS, SYSTEM AND METHOD TO LIMIT ACCESS TO OPEN NETWORKS BY REQUIRING THE CONSENSUS OF PRE-EXISTING NODES TO ADMIT CANDIDATE NODES

(71) Applicant: ZERO31SKYTECH INC., Toronto (CA)

(72) Inventors: Paul Christian Chafe, Toronto (CA); Jeffrey Lee Johnston, Toronto (CA)

(21) Appl. No.: 16/438,614

(22) Filed: Jun. 12, 2019

Related U.S. Application Data
(60) Provisional application No. 62/684,823, filed on Jun. 14, 2018.

(51) Int. Cl. H04L 29/06; G06Q 20/36

(52) U.S. Cl. CPC H04L 63/10; G06Q 2220/00; G06Q 20/3678

(57) ABSTRACT

Systems and methods govern participation in and enforce a limit on the number of nodes that can participate in a cryptocurrency or other distributed computing network. Unlike other approaches, systems and methods herein do not require excessive use of resources. Admission of a node to a network is governed by the consensus of pre-existing nodes using a process or physical characteristic of the candidate node to determine its eligibility. One instantiation uses physical location as the unique physical characteristic, with a distance constraint to force geographic separation between nodes. Another uses signal response time over the network as a proxy for distance, relying on the fact that network nodes cannot respond to an interrogation before it is received. Combined with an appropriate time constraint, this enables network space to be used as an analog for geographic space, despite the fact that network transmission speeds and paths are variable.

### CROSS-REFERENCE

This application claims the benefit of U.S. Provisional Application Ser. No. 62/684,823, filed on Jun. 14, 2018, and entitled “Apparatus, System and Method to Limit Access to Open Networks by Requiring the Consensus of Pre-Existing Nodes to Admit Candidate Nodes”, the entire contents of which are incorporated herein by reference.

### TECHNICAL FIELD

This description is related to the creation and operation of distributed networks in which a limitation on the eligibility of nodes to participate in the network is desirable. This includes networks that are capable of providing verification of transactions and computations, such as those which maintain a dynamic distributed ledger, blockchain, or other distributed computation and storage mechanism.

### BACKGROUND

Distributed networks consist of a plurality of processing nodes which are used to perform common processing operations and communicate through established protocols and links. A common application is the trading of unforgeable digital tokens between discrete identities (cryptocurrency transactions). These typically use blockchain or other forms of secure distributed ledgers to store information in a manner that cannot be altered without the consensus of a certain number of nodes on the network. Networks may incorporate redundant distributed storage. Networks exist which are Turing Complete (i.e., they can process any computable task in a secure and distributed manner). On such networks any application can be executed as a distributed application, using sequential and/or parallel computing techniques. Distributed applications that have transactional outcomes that depend on the results of such computations are known as smart contracts. Networks which implement reliable ordering of transactions are able to operate smart markets, which are wholly or partly self-regulating.

These networks known as fault tolerant. As the ledger and network are distributed, failure of a given subset of nodes will not prevent the network from continuing to operate, and will not cause loss of data in the distributed ledger. Networks which can withstand not just loss of nodes but dishonest nodes which actively try to cause faults are called Byzantine Fault Tolerant (BFT). Networks which are Byzantine Fault Tolerant in the face of delayed and/or lost messages between nodes are Asynchronous Byzantine Fault Tolerance (ABFT). In general, an ABFT network will continue to operate correctly as long as ⅔ of the nodes remain honest and are able to communicate.

Distributed networks maintain their integrity through network consensus mechanisms, with some mechanisms rewarding network nodes for correctly validating transactions and/or the results of computations. In the case of open (anyone can join) networks, nodes may be encouraged to participate in the computation and validation process through the distribution of tokens as rewards for the work done, which can then be traded on secondary markets for other tokens or currencies. However, a problem exists because there is nothing to stop a bad actor who wishes to disrupt network operations from adding a great many nodes. Such new nodes can easily form a majority consensus to falsify the results of computations and/or transactions. To prevent this, open networks are typically set up to require the nodes to make a measurable investment in the validation process, such that voting against the consensus will result in the loss of the investment, through an algorithm known as a proof-protocol. It is these proofs which impose the limit on supply necessary for digital tokens to serve as currencies.

In the process, operating nodes validate transaction blocks which are added to the distributed ledger or are otherwise recorded on the network. Distributed networks of this type embody distributed trust, meaning there is no requirement for a trusted central authority to clear transactions and ensure their validity. As long as the network is sufficiently decentralized, and appropriate proof protocols are used to ensure honesty among nodes, transactions which are validated by a sufficient number of nodes can be taken as valid.

Proof protocols act to make the network honest by rewarding consensus and thus making dishonesty costly. However, current protocols have a number of drawbacks. Proof of Work has nodes race to perform calculations that produce numbers with specific characteristics, with the node that first finds such a number adding the next block to the blockchain and being rewarded with tokens. The difficulty of finding a number is scaled by the amount of computing power on the network to keep the rate of discovery constant. This leads to a computational arms race, with nodes endlessly adding computing power to gain a larger slice of rewards. Attendant with this arms race is a massive increase in the amount of electrical power consumed, with some blockchain networks now using more power than medium sized nations. Because most of the work being done is directed at finding the required numbers, most of the computing (and electrical) power is wasted, and the transaction/computation rate of the system is very low compared to the resources used. A second problem, called centralization, exists in that if any single entity or co-operating group gains control of a quorum of the nodes on the network, this quorum can then vote in favour of invalid transactions, destroying the integrity of the system. However, the computing power arms race inevitably favours real-world economies-of-scale, rewarding actors with greater access to capital. This leads to smaller nodes becoming uncompetitive and dropping out, with the result that the network slowly loses the decentralization required to maintain distributed trust. Early blockchain networks using Proof of Work have already encountered these problems, with slow transaction rates, high power use, and correspondingly high transaction costs, with the networks simultaneously experiencing a high degree of centralization. These facts undermine the viability of Proof of Work systems in the long run.

An attempt to improve on Proof of Work is Proof of Stake. In this system nodes must provably hold tokens in order to be rewarded. As simply holding tokens does not require ever-increasing amounts of computing power, more capacity is available to process transactions, and the runaway arms-race condition of Proof of Work does not exist. In theory there is no economy of scale, as the cost of tokens is constant regardless of the number purchased. However, the purpose of gaining tokens on the network is not simply to hold tokens but ultimately to trade them for real-world goods and services. In this case, larger entities which can afford to hold larger percentages of their investment as stake on the network gain larger shares of the token rewards, and thus grow proportionally faster than small entities. This rich-get-richer effect also leads inexorably to network centralization. Other implementations include combinations and variations of Proof of Work and Proof of Stake, master nodes (which are de-facto centralized from the start) and other approaches to these issues. All of these offer suboptimal trade-offs, because efficiency is maximized when cost is minimized but, in an open system, trustworthiness must be underwritten by a real-world cost. Most costs are subject to economies of scale, which enables centralization. To date, no distributed trust system has managed to be simultaneously open, efficient, and centralization resistant.

### SUMMARY OF INVENTION

The systems, methods, and other aspects described herein allow the creation of an open, efficient, centralization resistant, trustable, distributed computing system without an arms race for stakeable tokens, electrical power, or other resource. Network computing power is focused on performing desired computations and clearing token transactions, leading to lower costs and more rapid completion of transactions and computations. Such a network is capable of secure digital token creation, transaction clearance, and secure distributed computing.

The systems, methods, and other aspects described herein use proof of verifiable physical parameters of the candidate node, such as computing speed, memory capacity, network throughput capacity, physical location, network signal response time (ping time), or any other parameter of the candidate that can be verified by the existing nodes. Limiting and granularity constraints are then applied with respect to these parameters in order to limit the number of nodes which can exist on the network at any given time. A granularity constraint defines the degree to which nodes must be individually distinguishable under the measured characteristic. A limiting constraint imposes a limit on the number of nodes that may join the network. Together, these constraints form a participation policy.

In general terms, the participation policy works to make network access a limited and thus valuable resource. For e.g., this enables the enforcement of the scarcity required to use network generated unique digital tokens as the basis for a currency (cryptocurrency tokens) or transaction ledger system, which gives value to network membership. This in turn enables the penalization of nodes which violate network consensus in terms of this value, which incents nodes to honestly co-operate in the operation of the network. In concert with this, network membership constraints prevent bad actors from overwhelming network consensus through unrestricted addition of dishonest nodes.

In operation, nodes already existing on the network decide whether or not to admit candidate nodes to the network by forming consensus on their eligibility based on the participation policy. Existing nodes make measurements with respect to candidate nodes, and then admit the candidates to the network if and only if these measurements satisfies the participation policy.

The constraints forming the participation policy may be formulated with respect to any parameter of candidate nodes which may be measured by the existing nodes on the network, including but not limited to computing capacity, as measured by the speed of solution of a particular problem, memory capacity, as measured by the ability to complete a problem with given memory requirements, network latency, as measured by interrogation/response time (ping time), network capacity as measured by throughputting a given amount of data in a given time, physical location, as measured by direct or indirect survey, proof of location in network space as measured by ping time.

Constraints may be relative to other nodes, for e.g. requiring that nodes are able to find a partner or partners with complementary capabilities, such as processing power and storage capacity. Constraints may operate in time, for e.g. requiring that a candidate node prove itself to be unique from all other nodes which have ever existed on the network, even if the competing nodes have since left the network. Constraints may involve precedence, such that a node may pre-empt a node which has left the network only until such time as that node returns. Such constraints implicitly increase in stringency with time. Constraints may also explicitly increase with stringency with time, e.g. steadily reducing the number of nodes which can exist on the network, or increasing the required computing or memory capacity of admitted nodes. Constraints may be conditional, such as a limiting constraint that increases to allow additional nodes to join the network as computing and/or storage demand increases.

The constraints may be fixed, or may vary according to a ruleset, for e.g. in order to adapt network computing and/or storage capacity to demand, or to provide redundant computing and/or storage to ensure continued operation in the face of node and network faults. The ruleset may also include criterion for dropping nodes from the network, distributing workload, distributing token rewards, prioritizing network traffic, encouraging node honesty, maintaining distributed trust, or other operations as are desirable to manage the operation of the network, and participation in it by the nodes.

The existing nodes individually measure the given parameters of candidate nodes, and the results are posted to a publicly available secure ledger. Existing nodes use this information to reach consensus on the admissibility of each candidate node under the participation policy. Candidates which meet the requirements of the participation policy are allowed to participate in network operations. Candidates which do not meet these requirements are not allowed.

The underlying principle is that the network effects collective self-government, according to parameters which the nodes themselves may measure. The participation policy encompasses rules that admit nodes, eject nodes, and otherwise manage the operation of the network with regard to granularity, limiting, and other constraints. These rules are designed to give the network whatever properties may be desired, including reliability, scarcity, resistance to centralization, distributed trust, scalable storage, scalable processing power, and any other properties which may be controlled through the participation policy

The platform so constructed can then be used for the secure, distributed completion of arbitrary computations, completed redundantly, in parallel or serial, including but not limited to digital token exchange, public distributed storage, the execution of smart contracts, the operation of smart markets, and combinations of these.

In greater detail, when a candidate requests admission to the network, the request is propagated to all existing nodes, which then perform measurements of given parameters of the candidate node to determine if it is admissible under the participation policy. If so the node is admitted to the network, its identifying information, such as cryptographic public key, network address, hash signature, and/or other identifier, is entered on a distributed ledger maintained by the network, and it may then begin participating in network operations. If parameters measured by the existing node do not meet the requirements under the participation policy, its information is not published on the ledger, and it does not participate in network operations.

Within the participation policy, the simplest possible granularity constraint is a unique and unforgeable identifier assigned to each node, for e.g. a public key cryptography key pair used to digitally sign communications. The simplest limiting constraint is a numerical limit to the number of unique identifiers which may simultaneously operate on the network.

As embodied using a defined metric of physical space as the granularity constraint, the nodes must be a minimum distance from each other. Candidate nodes may only join the network if they are outside the granular region occupied by any pre-existing node. A physically limited space (for e.g., the planet's surface) is used as the limiting constraint. Together, these limit the number of nodes that can exist on the network. This embodiment additionally enforces geographic distribution of nodes on a global scale, making it very difficult for a single entity to control a quorum of nodes. This in turn enhances the ability of the network to maintain distributed trust over the long term. Distance measurements may be direct or indirect, and standard surveying and trigonometric techniques may be used to verify the physical location of candidate nodes.

As embodied using a defined granularity of network space as a proxy for physical space, the same logic applies. Network space is a topological metric space which is related to physical space through a continuous, homeomorphic transformation. It is constructed based on nodes existing on a network using transmission times as a metric. As physical location is difficult to measure, indirect measurements using network interrogation/response time (ping time) are used to construct this space using the relative ping times between nodes to define a theoretical volume which maps to geographic space. This mapping will be inexact but will have geometric and topological properties which enable it to be used in the same way as physical space to impose a limit on the number of nodes that can exist within it. In particular, nodes exist on the network on a mesh defined by the ping times between them, and constraints are applied as in the physical case to limit their locations and numbers.

In all embodiments, the network as a whole finds consensus on the admissibility of nodes by making measurements which are posted to a secure public ledger and then applying a ruleset to them. The nodes may periodically re-verify the admission parameters of each other simply by repeating the measurements and again posting them to the distributed ledger. Network admission may then be revoked or modified based on these histories, again using whatever metric is most useful to achieve the specific purpose of the network.

In order to prevent dishonest nodes from giving admission to nodes which should not be admitted, nodes which act against the consensus may be subject to penalties. This may include ejection from the network, having token rewards reduced or removed (in the case of a cryptocurrency network), having a trustworthiness score reduced, or other penalties which are useful for enforcing compliance with the consensus rules. These penalties serve to make it in the best interest of every node to act honestly with respect to every other node on the network.

In order to prevent dishonest nodes or external actors from intercepting and modifying internode communications to gain access to the network, any of a number of encryption methods, including public key cryptography, and quantum resistant public key cryptography, may be used in order to ensure the security of the process. Likewise, the interrogation/response pairs may be encrypted in order to avoid external interference.

There is provided a computer-implemented method to control participation in a distributed network through a consensus of a plurality of existing nodes within the distributed network. The method comprises: receiving, at one node of the plurality of existing nodes, a request to for a candidate node to join the distributed network; evaluating, by the one node, a measure of eligibility of the candidate node to join the distributed network using a participation policy, the participation policy requiring the candidate node to comprise one or more physical characteristics to evaluate the measure of eligibility; determining, by the one node, whether the consensus of the plurality of existing nodes is achieved, wherein the consensus is achieved through integration of the measure of eligibility evaluated by the one node with respective measures of eligibility from other nodes of the plurality of existing nodes according to a consensus model to permit or deny participation to the candidate node; and communicating with the candidate node following an admission of the candidate node to participate in the distributed network in response to the determination of the nodes.

The physical characteristics of the candidate node may comprise any one or more of computing speed, memory capacity, network throughput capacity, physical location, network signal response time (ping time), and any other parameter of the candidate node that can be verified by each of the plurality of existing nodes. The physical characteristics of the candidate node may comprise a minimum physical distance between the candidate node and each of the plurality of existing nodes.

The participation policy may comprise a requirement that the one or more physical characteristics of the candidate node are unique and discrete from each of the plurality of existing nodes. The participation policy may comprise a requirement that the physical characteristics of the candidate node are unique and discrete from each of the plurality of existing nodes and all other nodes which have ever existed on the distributed network.

The participation policy may comprise a requirement that the physical characteristics of the candidate node meet conditions of increasing stringency with respect to each of the plurality of existing nodes on the distributed network.

The method may comprise, by the one node and in respect of another node of the plurality of existing nodes: periodically determining a respective measure of eligibility in respect of the another node to remain within the distributed network in accordance with the participation policy; and providing the respective measure of eligibility for determining by the plurality of existing nodes whether the another node remains within the distributed network according to a consensus achieved among the plurality of existing nodes, each of the plurality of existing nodes reviewing each respective measure of eligibility for the another node according to the consensus model to permit or deny participation within the distributed network.

Physical location may be one of the physical characteristics in the participation policy.

Signal response time may be one of the physical characteristics in the participation policy. Signal response time over a packet switched network may be one of the physical characteristics in the participation policy. The one node may measure the signal response time between the one node and the candidate node to determine the measure of eligibility to establish unique locations for each of the plurality of existing nodes in a network space defining the distributed network. Signal response time triangulation between the plurality of existing nodes may be used to establish a network space location constraint for application to the candidate node for use as one of the physical characteristics in the participation policy. The one node may measure a signal response time between the one node and the candidate node to verify a physical or network space location of the candidate node which has been established by other means as one of the physical characteristics in the participation policy.

The participation policy may require that each node within the distributed network be distributed with a specified amount of granularity with respect to the one or more physical characteristics of the participation policy, including, optionally, where a granularity specification is allowed to vary either in time, space, or both.

There is provided a node on a distributed computing network configured to perform a method in accordance with any of the methods provided. The node may be further configured to perform computing tasks, either alone or together with other nodes of the distributed network. The node may be further configured to determine the validity or correctness of the computing tasks performed by other nodes through the consensus of the plurality of nodes on the distributed network.

The node may be configured to perform the computing tasks to create unique digital tokens created through cryptographic proof-of-work, proof-of-stake, other proof protocol, or other method. The node may be configured to exchange unique digital tokens as between unique identities established on the distributed network. The node may be configured to exchange unique digital tokens for arbitrary transaction settlement. The node may be configured to exchange unique digital tokens for a given amount of computing work. The unique digital tokens may be exchanged for a given amount of computing work according to a network-wide price for the computing work. The unique digital tokens may be exchanged for a given amount of computing work according to an automated market based on user settable prices for computing work.

The node may enable a verification of transactions using unique digital tokens or other transaction tracking mechanism by the consensus of the nodes on the network.

The node may store on the node a permanent record of each transaction and/or other data related to the normal operation of the network.

The node may comprise one or more processors and a storage device coupled thereto, the storage device storing instructions which when executed by the one or more processors configure the node to operate.

There is provided a computer program product comprising a non-transitory storage device (for example, a memory, disc, etc.) storing instructions which when executed by one or more processors of a node (for example. a computing apparatus) configure the node to perform any of the methods.

There is provided a distributed network comprising a plurality of nodes as provided.

### DESCRIPTION OF DRAWINGS

FIGS. 1A-1E illustrate the addition or rejection of candidate nodes to a network built with signal response links which operate at the speed of light, over straight lines. This allows trigonometry based on signal-response time to determine if a candidate node satisfies the required location granularity constraints within the limiting constraint of the network's physical geometry.

FIGS. 2A-2H illustrate the addition or rejection of candidate nodes to a network joined with indirect signal response links of varying path and speed. To accomplish this we assume that all links are geodesics and operate at the speed of light, and use these as metrics to construct network space as a continuous homeomorphic transformation of physical space. We may then determine if nodes satisfy the required location granularity constraints within the limiting constraint of the network space geometry.

FIG. 3 illustrates the construction of network space on a global scale with inner and outer limiting constraints. The inner limiting constraint is the surface of the earth. As nodes cannot communicate faster than speed of light geodesic links on this surface, this puts a minimum limit on ping time. The outer limiting constraint is constructed by measuring actual ping times, and assuming that all links are geodesics operating at the speed of light. This creates a spheroid which is a continuous homeomorphic transformation of the physical locations of the nodes on the planet. We may then determine if nodes satisfy the required location granularity constraints within the limiting constraint of the network space geometry.

FIGS. 4A-4C are a flowchart of operations for the addition or rejection of a candidate node, showing respective operations for the candidate node, which contacts an existing node (Node A), and further nodes of the existing network.

### DETAILED DESCRIPTION

Open networks are desirable, but face an issue in ensuring the honest operation of network nodes when anyone can join. When used to support a cryptocurrency, they also face the issue of imposing the limited availability required to make a currency valuable. Current solutions to these issues have problems with centralization and runaway power demand. These can be solved by using location as a limiting resource on network participation. By limiting the number of sites available to run network nodes, space itself becomes a commodity to be competed over, eliminating the need to compete through energy expenditure, wealth commitment or other real-world investment. Simultaneously, centralization is prevented by enforcing the distribution of nodes on a global scale. The space used may be physical space, or may be a proxy for physical space such as network space, which is defined here as a multidimensional space which is a continuous, homeomorphic topological transformation of physical space. In this implementation, it is constructed through measurement of the network signal/response times (ping times) on the network connecting the nodes.

Because operating a node has value, node operators may be motivated to dishonestly report their location in order to join the network. Therefore candidate nodes cannot be simply asked to provide their location without verification by the existing nodes on the network. As embodied using physical space, the existing network nodes may verify candidate node location by dividing the surface of the Earth into triangular regions with geodesics that link neighbouring nodes. The distance from the surrounding nodes to a given candidate node can be measured by triangulation using standard surveying techniques. The limiting constraint in this case is the surface of the earth, and the granularity constraint is a specified minimum distance that nodes must be from each other. These two constraints impose an upper limit on the number of nodes which can participate in the network. If a candidate node meets these constraints the node is allowed to join the network.

Direct measurement of location through surveying can be improved by using signal response time as in laser or radar range-finding. Signal response time measurement is made by sending an interrogation signal to a node, which then responds as fast as possible. At the interrogating node, the distance to the candidate node is proportional to the time delay between sending the interrogation and receiving the response. Candidate nodes could try to be deceptive by adding delay to their response, but this can only make them appear to be farther away from the interrogating node. As they cannot respond to an interrogation before it's sent, they cannot ever appear to be closer. Triangulating the location of a node which has added delay to its responses will yield a three dimensional location solution which does not lie on the surface of the earth, and thus does not satisfy the limiting constraint. This allows the disqualification of nodes which try to be deceptive about their location.

It is desirable to be able to make measurements over the same links that nodes use to communicate, (e.g., the internet). However, these operate at uncertain speed over indirect paths, and both paths and speeds can change at random. Signal response time is thus variable and cannot be used for direct distance measurement. However it remains impossible for a candidate node to respond to an interrogation before it's sent. This observation allows us to substitute network space as a proxy for physical space, using network ping times for triangulation.

Network space is a finite space, typically of three dimensions although implementations may be constructed using two or more dimensions. In the three dimensional case an imaginary surface is constructed by measuring signal response times between several globally distributed initial nodes with known locations, and computing relative node locations as if these connections were completed over geodesic segments operating at the speed of light. Given that network speeds are much lower than the speed of light, this imaginary surface is much larger than the Earth, and forms the outer boundary of network space. The inner boundary is the actual surface of the Earth as it would be defined by a network at ground level, connected by geodesic segments operating at the speed of light. The volume between these two boundaries, is then defined as network space, which serves as the limiting constraint in this implementation. Candidate nodes which prove themselves to have faster connections to a subset of existing nodes than those nodes have with each other will be located within network space. Node scarcity and geographic dispersion are then enforced with a time-domain granularity condition.

These constraints mean that surface of the outer boundary of network space contracts towards the Earth's surface as nodes are added to the network, and so the number of potential nodes which can exist within this volume is strictly limited. This property enforces both decentralization and a finite limit to the number of nodes which can exist on the network. This in turn enables an open network with low energy use, no embedded wealth commitment, rapid transaction clearance, high computational efficiency, and resistance to centralization.

As network routes and transmission velocities may vary, statistics may be used to identify node locations, making the network space transformation probabilistic in nature. This may be done by using (e.g. choosing) the medial point, the average point, or finding the point which minimizes root-mean-square error of each point in the dataset. Further techniques may use the median, average, or best-so-far response times, eigenvalue decomposition of the ping time history, including more sophisticated eigenvector based analysis such as elastic maps. These may be applied within given time windows which may themselves be filtered, weighted, or otherwise variable, and the data history may be processed with various filters, such Gaussian, Laplacian, and/or others. More sophisticated measures including neural networks, genetic programming, and other artificial intelligence techniques, may be applied to develop functional parameterizations of internode network space metrics, their variability, and the applicable limiting and granularity constraints.

Such analysis techniques are useful in all embodiments by allowing probabilistic rather than deterministic measurements to be made, increasing the flexibility of the network and allowing its operation in a changing or uncertain environment where errors and interference exist.

The further properties of the network may then be chosen as desired by the network designer. Potential applications include but are not limited to networks which run distributed computing applications, provide distributed data storage, enable cryptocurrency or digital token exchange, execute smart contracts (i.e., code with guaranteed value transfers as potential outcomes to its execution), and/or operate smart markets (i.e., markets implemented as a distributed computing application). Various combinations of these are possible, for e.g. a smart contract which transfers value within a smart market using digital tokens based on the results of a distributed computation which relies on a distributed database for its execution.

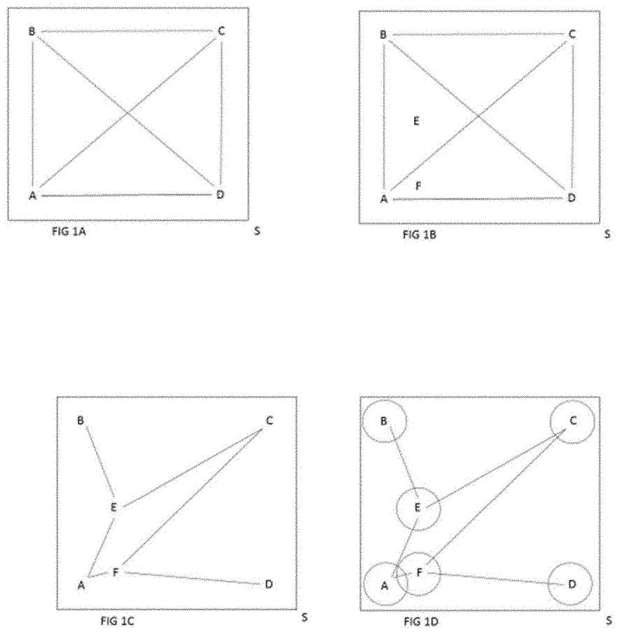

A simple illustration of use of physical space to constrain a network for this purpose is shown in FIG. 1A. This shows a bounded physical planar surface S initially occupied by a network of several nodes, A, B, C, D. S is bounded by a limiting constraint defined with respect to A, B, C, and D, for e.g. the area bounded by these points, or a larger area defined with respect to any or all of them, individually or with regard to various geometric relationships between them, such as the centroid of the polygon they define, or other measure. However defined, the boundary of S forms a limiting constraint. Straight line, speed-of-light signal response links exist between AB, AC, AD, BC, BD, and CD. In this case the distance AB is equal to time T(AB)/c where c is the speed of light. As such, these links define the relative geometry of the network.

FIG. 1B shows two candidate nodes, E, F, located within the area defined by ABCD, which wish to join the network. Each of E and F initiate a request to join the network. This request is propagated to the network. This may be done by having the candidate nodes continue to contact additional nodes, by having the contacted node directly inform all the nodes it knows about, by having the contacted node contact other nodes at random, which in turn contact other nodes at random, until the message has been spread to the entire network, or through other message passing algorithms. Once an existing node is aware of a candidate node, it interrogates the candidate with ping requests, measuring the time it takes for them to respond. These measurements are recorded on the public ledger, which is shared across the network.

As all existing nodes have access to the public ledger and use the same ruleset to determine admissibility, they will automatically agree as to the admissibility of a candidate node once sufficient measurements have been made available. The criterion for “sufficient” may be chosen to suit the demands of the network, possibilities include recording measurements from all existing nodes, a quorum of existing nodes, a fixed or varying percentage of existing nodes (normally greater than 50%) known to be active within a given time period. These rules themselves may be fixed or variable depending on further conditions, such as network activity, transaction volume, compute load, storage demands or any other parameter which may be measured by the nodes.

FIG. 1C shows such straight line, fixed speed signal response links established to E from A, B, and C, and to F from A, C, and D. Note that in general application, interrogation is not limited to the immediately surrounding nodes, any or all existing nodes may participate in this measurement, and normally will. Because the links are straight and the velocity is fixed, the distance between points is proportional to the time required for the signal to be sent and returned from the interrogating node. Because the relationship between A, B, C, D is fixed, measuring signal response time on links to E and F enables the determination of their locations on the plane of S by standard trigonometric techniques, for e.g., determining the common intersection point of circles with centres at A, B, C and D and with radii equal to the distances. This method does not require the measurement of angles. As signal response time is directly proportional to distance, the calculation remains valid if the times are used directly for this calculation, with the node relationships then existing in a mathematical space which is congruent with but separate from physical space on the plane.

FIG. 1D then shows a granularity constraint applied, such that nodes are only permitted to join the network if they are outside a distance equal to the diameter of the illustrated circles. E is admitted, but F is rejected due to its proximity to A. This determination is made independently by all existing nodes on the network based on the information in the shared public ledger, but all nodes use the same metrics and constraints and so will universally reach the same conclusion as to the admissibility of the candidate nodes.

FIG. 1E shows the network configuration with E now on the network and available to make measurements to subsequent nodes which wish to join. The addition of E reduces the number of sites available for subsequent nodes to join the network within the framework defined by A, B, C, and D. Note that the granularity constraints and other parameters can be allowed to vary if so desired. Additional constraints can also be added (e.g., specifying a maximum distance as well as a minimum distance).

Note that F could dishonestly try to gain network admission by delaying its signal response to A, thus making it appear farther away from A, while responding immediately to C and D. However, with the limiting constraint that candidate nodes must be on the same plane as the existing nodes, this is not possible. Delaying any response results in a triangulated result for the position of F which is not in the plane of S, i.e., the triangulated z-co-ordinate (height) will be non-zero.

F could also dishonestly try to gain network admission by initiating its admission request at an open location, and then physically moving to a prohibited location. This is prevented by having the nodes on the network interrogate the relative positions of all other nodes at regular intervals, and not accepting participation from those which are demonstrated to have moved from their initial locations. As measurements may have errors, statistical techniques may be used with boundary conditions to determine if a node has moved (e.g. as described herein above). Over time, measurement errors will statistically define a volume in network space occupied by each node. These specific statistics, the limiting constraints, and the granularity constraints can be varied in order to enable the network to adapt to changing conditions. This variation in turn is governed by a set of rules to which all nodes conform.

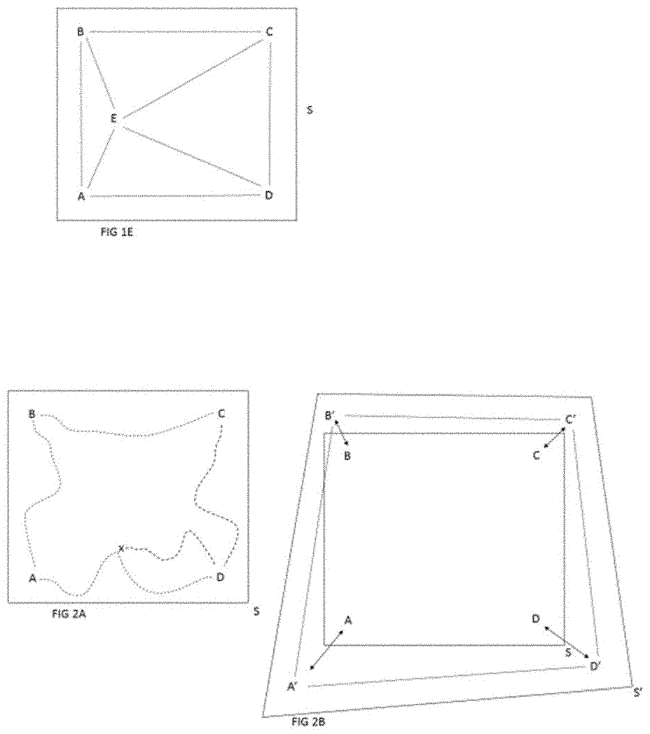

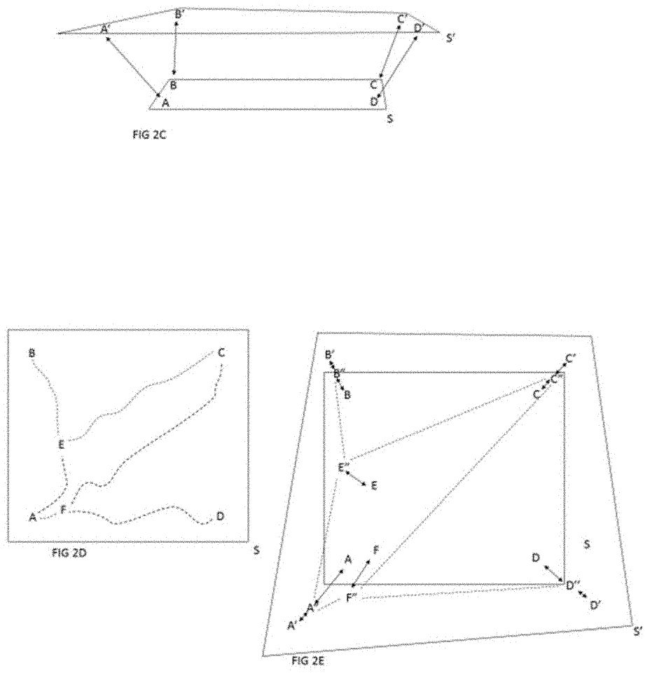

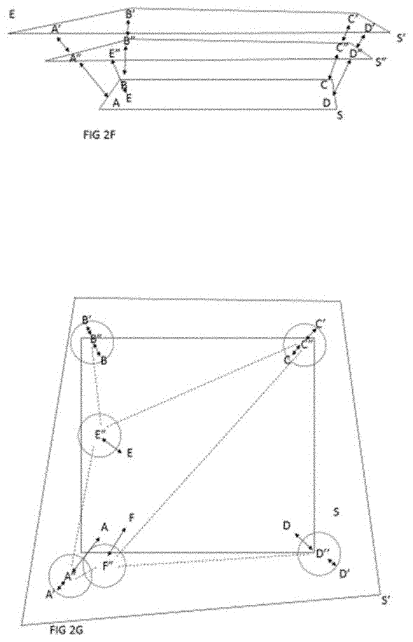

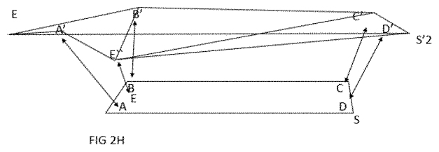

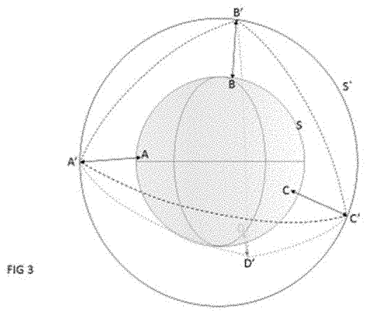

A more sophisticated version of this process accounts for variability in network connections and introduces the concept of network space. FIG. 2A shows the same relationship between A, B, C, and D, this time using network links of variable length and transmission speed, (e.g. on a packet switched network such as the internet). These links may optionally including intermediate repeaters, as shown at point x, which allow variable link paths and may add additional delay to the signal response. In this case triangulation to determine node locations is not possible because distance and velocity are neither known nor constant. However, the establishment of appropriate constraints using relative location is still possible using the concept of network space. Network space is defined as the relationship between nodes as it would exist if all the links were straight lines and operated at the speed of light, extending the node positions into three dimensions along fixed angles chosen to maximize orthogonality. This creates a projected surface S′, with the node locations A′, B′, C′, D′ related to the locations of A, B, C, D on the physical plane illustrated in FIG. 2B.

FIG. 2C show the relationship between S and S′ in three dimensions. S′ is constructed so as to minimize the derivative of curvature at every point, note that in real-world cases S′ will usually be a curved surface. Other constructions are possible, for e.g. using flat planes between lines AB, AC, AD, BC, BD, CD. On S′, A and B are separated by a geodesic with length T_{AB}/2c, where T_{AB} is the ping time from A to B and back, and c is the speed of light. Network space is then defined as the space between S and S′. Note that other projection formula can be used to suit particular cases.

Candidate node location is done as detailed in the first case, by determining the intersection point of spheres centred on each node with radius equivalent to the measured distance by signal response time from that node. Adding nodes also proceeds as in the first case, with the provision that candidate nodes are able to join the network only if the collective measurements stored on the distributed ledger shows them to be within network space (i.e. constrained between S and S′), rather than on a simple plane. FIG. 2D shows triangulation to E and F, using indirect and variable speed links. To determine if a candidate node may join the network the signal response times are used to determine its location, under the assumption that all links are geodesics operating at the speed of light between a point A″, B″, C″, D″, projected from A′, B′, C′, D′, towards A, B, C, D, and a point projected from the candidate nodes E, F on S towards S′, subject to the constraint that the distances A′A″, B′B″, C′C″, D′D″, EE″, and FF″ are minimized, resulting in the surface S″. These constraints are equivalent to requiring candidate nodes to have faster and/or more direct links than the links already established.

This is shown graphically in FIG. 2F. FIG. 2G illustrates the granularity constraint being applied, this time as the diameter of a sphere rather than a circle. This results in E being admitted to the network, and F rejected. Note this granularity constraint may be achieved through a number of measures which may be applied using measurements from a plurality of the surrounding nodes, combined with an appropriate statistic. Again, F can attempt to falsify its location by adding delay to its response to interrogation by A, but this will result in a trigonometric solution to its position in network space which is outside the volume defined between S and S′ and this is prohibited by the limiting constraint. This constraint also disqualifies candidate nodes whose link speed and distance place them outside the volume to begin with. E's presence results in a new surface S′₂, shown in FIG. 2H. As there is less volume between S and S′₂, than there is between S and S′, and new nodes are also limited by the granularity constraint from the proximity of E, it can be seen that the availability of valid locations on the network always decreases as nodes are added, and thus the total number of nodes is strictly limited. As the network approaches capacity, the distribution of nodes will become roughly uniform, as the granularity constraint forces a minimum distance between them.

This process can be extended to global scale with the initial nodes being globally distributed. In this case the surface of the Earth serves as surface S, and surface S′ is constructed using geodesics on an imaginary spheroid surrounding Earth. FIG. 3 illustrates this process. Given a minimum of four widely separated initial nodes A, B, C, D on S forming four coplanar sets in three dimensions, the ping time is measured between each of the six possible pairs. The surface S′ is constructed by projecting the node locations outward from the centroid of the initial sphere (i.e., the surface of the Earth) towards points A′, B′, C′, D′, co-resident on a spheroid with radii such that the spherical geodesic distance computed between the projected points is equal to the ping times multiplied by c, the speed of light. This will result in six such geodesics, which form the framework for a single surface by holding the geodesic segments constant and numerically adapting the intervening areas to minimize the first derivative of curvature between them, resulting in an irregular ellipsoid.

Given these initial conditions, localization of a candidate node in network space with respect to S and S″ may be computed by measuring ping time as described above, finding the geodesic distance between the initial nodes and the candidate, finding the plane of each geodesic, and the line of intersection of each pair of planes, and then the intersection point of these lines of intersection. As measurement errors will exist it is not guaranteed that these lines will in fact intersect at a point. However by computing the centroids of lines connecting the lines of intersection at their closest approach a dataset can be constructed which defines a region. Statistical methods can then be used to determine a network space location of the candidate node, as laid out herein above. Candidate nodes found to be within the volume between S and S′ and not violating the granularity constraints are then admitted to the network, with the surface S′ modified to S″ by the same procedure detailed above. In this manner the volume available for new nodes continuously contracts, and so the limitation on node membership is achieved within an open system. Simultaneously, geographic dispersion of nodes is enforced.

In detail, this may be done by determining the spherical geodesic distance L between nodes A and B:

$${L}_{AB} = r arcos ( cos ( \frac{1}{2} π - {A}_{lat} ) cos ( \frac{1}{2} π - {B}_{lat} ) + sin ( \frac{1}{2} π - {B}_{lat} ) sin ( \frac{1}{2} π - {A}_{lat} ) cos ( {B}_{lon} - {A}_{lon} ) )$$

where r is the radius of the Earth and latitude and longitude are expressed in radians. The radius R_{AB} of the geodesic in network space is then:

$${R}_{AB} = \frac{c {T}_{AB}}{{L}_{AB}}$$

where c is the speed of light, and T_{AB} is the ping time between A and B. This process is repeated for subsequent node pairs AC, AD, BC, BD, CD, and etc. as required.

Similarly the azimuthal angle θ_{AB} between A and B, is determined through:

$${θ}_{AB} = \frac{arc sin ( sin ( \frac{1}{2} π - {B}_{lat} ) sin ( {B}_{lon} - {A}_{lon} )}{\begin{matrix}sin ( arcos ( cos ( \frac{1}{2} π - {A}_{lat} ) cos ( \frac{1}{2} π - {B}_{lat} ) + \\ sin ( \frac{1}{2} π - {B}_{lat} ) sin ( \frac{1}{2} π - {A}_{lat} ) cos ( {B}_{lon} - {A}_{lon} ) ) )\end{matrix}}$$

A candidate node N may then be added to the network if and only if there exists at least three nodes ABC such that T_{AN}<T_{AB}, T_{AN}<T_{AC}, T_{BN}<T_{BA}, T_{BN}<T_{BC}, T_{CN}<T_{CA}, T_{CN}<T_{CB}, and T_{AN}>T_{g}, T_{BN}>T_{g}, T_{CN}>T_{g}, where T_{g} is the granularity constraint, normally expressed in microseconds (μs).

The network space distance L_{AN} from A to N is then given by cT_{AN}, with geodesic radius found as above.

The network space angle α_{BAN} from B to A to N is then given by:

$${α}_{BAN} = \frac{cos ( \frac{{L}_{AB}}{{R}_{AB}} ) - cos ( \frac{{L}_{AN}}{{R}_{AN}} ) cos ( \frac{{L}_{BN}}{{R}_{BN}} )}{sin ( \frac{{L}_{AN}}{{R}_{AN}} ) sin ( \frac{{L}_{BN}}{{R}_{BN}} )}$$

Azimuthal angles to possible locations of N are then given by:

θ_{AN}¹=θ_{AB}+α_{BAN}, and θ_{AN}²=θ_{AB}−α_{BAN}

Repeating this calculation at B and C will show three angles converging and three diverging. The convergent angles are redesignated θ_{AN}, θ_{BN}, θ_{CN} and are then used to compute the network space location of N with respect to each of A, B, C:

$${N}_{lat} = \frac{1}{2} π - arcos ( cos ( \frac{{L}_{AN}}{r} ) cos ( \frac{1}{2} π - {A}_{lat} ) + sin ( \frac{1}{2} π - {A}_{lat} ) sin ( \frac{{L}_{AN}}{r} ) cos ( {α}_{BAN} ) \\ {N}_{lon} = \frac{{A}_{lon} + arc sin ( sin ( \frac{{L}_{AN}}{r} ) sin ( {θ}_{AN} )}{\begin{matrix}arcos ( cos ( \frac{{L}_{AN}}{r} ) cos ( \frac{1}{2} π - {A}_{lat} ) + \\ sin ( \frac{1}{2} π - {A}_{lat} ) sin ( \frac{{L}_{AN}}{r} ) cos ( {α}_{BAN} )\end{matrix}}$$

Because of network variability, these locations will not generally be found to be the same point. Accordingly the actual network space location for the candidate node can be computed using the techniques as described herein above to better characterize the topological metric transform, which may be further refined using a probabilistic model. Note that in this case the network space location will not be a point but a region.

In this description only three neighbouring nodes are used to determine the network space location and so eligibility of a candidate node, as this is the minimum necessary to determine these criterion. However, any and all other nodes can participate in the process, and to the degree that additional measurements improve the assessment of the data, they should be used.

Other methods of construction are also possible to achieve the same general result of a ping-time defined transformation from S to S′, for example using straight line segments rather than geodesics, resulting in a surface S′ which is polyhedral rather than continuously curved. Additional accuracy in S can be obtained using surveyed geodetic datum such as WGS 84 rather than a simple spherical model, with appropriate ellipsoidal corrections.

Optionally, weightings can be assigned to the value given to the measurements made of a node by other nodes based on their relative location. Higher values are given for the accuracy of the assessments of closer nodes, as there is less variability in network path and fewer transmission delays. Higher values are given to the reliability of more distant nodes, as they are less likely to be impacted by local events which may compromise the operation of nodes in the same region in the same way.

Location verification can also be implemented using any characteristic which unpredictably but verifiably varies across node locations. For example the time-of-receipt of a specific segment of the encrypted pseudo-random code embedded in navigation satellite signals (for example the P(Y) and M codes used by the GPS constellation) can be used to verify the physical location of a candidate node, since nodes which are physically close to the candidate will receive the same code at the same time, and can verify that the candidate broadcast the verification faster than it could be transmitted over the network from the other side of the world. This implementation uses the fact that the code sequence cannot be predicted beforehand, that its arrival time varies as a function of the angle between the satellite and the zenith, and that locations below the satellite's horizon will not receive the signal at all. Used in this way, the network is able to independently verify the location of nodes at a distance. This is separate from the typical use of satellite navigation systems, in which a ground receiver computes its own location. This instantiation uses the satellites only as a source of a positionally varying, unpredictable, but verifiable data stream

Using satellites orbiting at a height H kilometres, given the earth's average radius r, L is the distance to a satellite on the horizon is:

L=\sqrt{r²+(r+H)²}

The path length difference D from viewing the satellite at the zenith to viewing the satellite on the horizon is then:

D=L−H

The signal time-of-flight difference T_{S} between the satellite and a node with the satellite at the zenith, and the satellite and a node with the satellite on the horizon is thus:

$${T}_{S} = \frac{D}{c}$$

The arc distance A over the surface of the planet from zenith to horizon is:

$$A = \frac{1}{2} π r$$

Therefore, the minimum time T_{N} taken for a network signal at net velocity V, verifying the receipt of the satellite signal to reach a node with the satellite on the horizon from a node with the satellite at the zenith:

$${T}_{N} = \frac{A}{V}$$

This gives the time ratio T_{S}/T_{N}. As A must be larger than D due to the geometry, and V must be less than c as network speeds must be lower than the speed of light, this ratio must always be less than 1. Assuming V=c sets the minimum fraction of A that the measured node may be from the measuring node. As the candidate node will only be able to report the code sequence while the relevant satellite is above the horizon, measurements from many nodes located around the globe, will definitively establish the hemisphere the candidate node is in with respect to the satellite. Successive measurements made as the satellite orbits, and/or using many satellites are then used in calculations generally similar to those described under the process of global ping-time triangulation described herein above to refine the network space location of the candidate node with respect to the other nodes on the network, and/or to relate this to its physical location.

Similar calculations apply to measurements taken from nodes intermediate between the zenith and the horizon.

Other implementations, are possible, for e.g. using time of receipt of predictably present but unpredictably variable signals from distant sources, such as communications satellites in geosynchronous orbit, other satellites, cosmic ray flux levels, solar flares, pulsar variations, etc.).

Optionally, in addition to external measurements of its location, a node can declare its geographic location either directly (for e.g. by adding a latitude and longitude, street address, or other data identifying its physical location) or indirectly (eg by IP address localization service) when requesting admission to the network and this can be used as an additional constraint in relating physical space to network space. In this case the declared location acts as a form of contract, with the node committing that the network's external measurements will ultimately show it to be at the location it where it has declared itself to be. Its probability of correctness can be assessed using Bayesian statistics, where P(L), the probability that the location is correct is equal to the probability that the location is correct given the observed data multiplied by the probability of observing the data, divided by the probability of observing the data given that the location is correct, formally written P(L)=(P(L|T)×P(T))/P(T|L), where P(L|T) is the probability of the location being correct given the dataset, P(T) is the probability of observing the dataset, and P(T|L) is the probability of observing the data given that the location is correct.

These probabilities in turn can be extracted from the data on the public ledger using the analysis techniques described herein above. There is no assumption that the declared location given by the candidate is correct, rather the probability of the location being correct is used as a further constraint on the topological construction of network space. Once supported by the measurements, location declarations enable a more direct mapping between physical space and network space. Candidates whose declarations are not supported by the measurements can be ejected from the network, be accepted to the network but have their declarations ignored in defining network space, or be otherwise handled. Additional accuracy can be gained using surveyed geodetic datum with respect to location declaration. Implementations without location declaration are possible.

The above descriptions are illustrative but not exclusive, and many variations on these techniques are possible within the scope of this invention.

Various measurement techniques may be combined in order to improve accuracy, to cross-check the system, and to provide redundancy of operation.

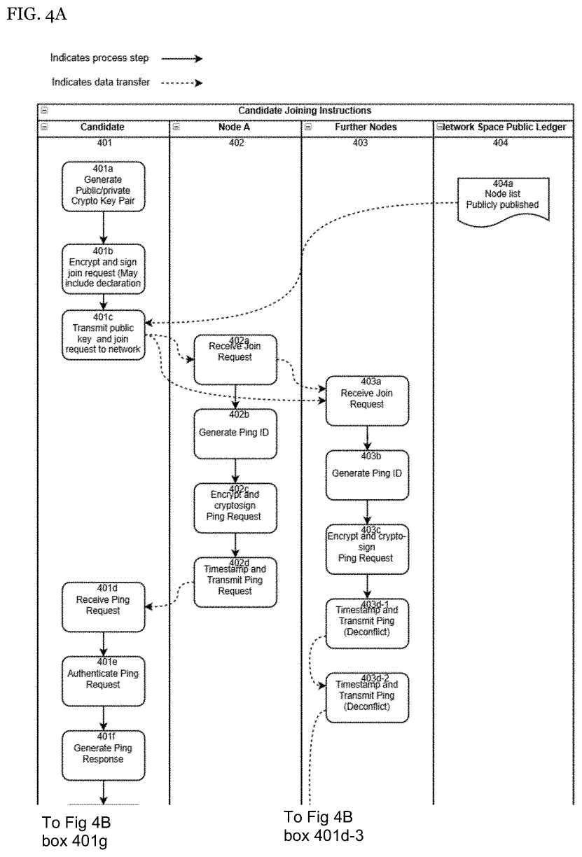

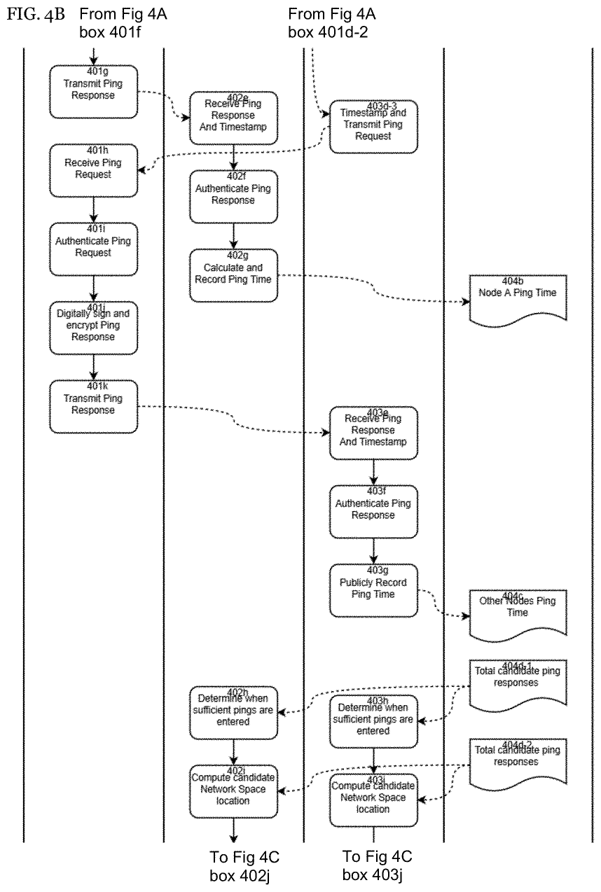

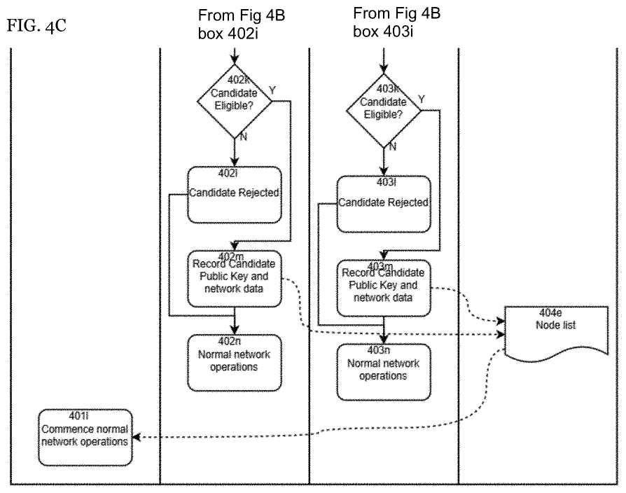

FIGS. 4A, 4B, and 4C show a flowchart of operations for the addition or rejection of a candidate node to enforce participation in a distributed network using network space location as the physical characteristic measured and constrained. This shows respective operations for the candidate node, a first node (Node A) of the existing network and further nodes of the existing network. In this example, the process of a candidate requesting admission to the network and having its eligibility assessed by other nodes is based on ping time, computed network location, and the consensus of the previously existing nodes. In general, this process involves the following steps.

A candidate node (401) requests admission to the network. This step proceeds through the generation of a public key cryptography key pair (401a). This key pair serves to uniquely identify the node on the network from this point forward. A join request is created and cryptographically signed used the key pair (401b), and the public key and signed join request is transmitted to a pre-existing node (402) chosen from the network public ledger (404a) or other network point of contact made publicly available by nodes, such as hypertext transfer protocol (HTTP) page, internet relay chat (IRC) or other distribution channel. In some implementations the candidate node may then contact further pre-existing nodes (403) on the network directly through one of a number of schemes, including randomly contacting peers (gossip protocol) or contacting peers according to a scheduling scheme based on the network space location of peers, binary search of the ordering of the peers known to the node, or other scheme

The contacted node (402) registers the join request (402a) and generates a unique ping identifier (402b), encrypts and digitally signs it (402c) using its own public key, and transmits a ping request back to the candidate node, recording a timestamp at the instant the request was sent (402d). In some implementations the contacted node may also further propagate the join request to further nodes, again using the public ledger's list of active nodes or other distribution channel as described above.

The candidate node (401) receives the ping request (401d), authenticates it (401e), generates a response using the unique ping ID, digitally signs and encrypts it, and transmits it back to the originating node (401f). In implementations where the join request is propagated across the network by existing nodes or asynchronously by the candidate nodes, two or more simultaneous ping requests may be received by the candidate. As delay in ping response is undesirable, simultaneous requests are deconflicted by any of a number of standard techniques (for e.g., the ALOHA method, in which conflicting requests are canceled and then repeated after a random delay interval until a conflict free request can be answered) in order to ensure that ping-response time is not adversely influenced by request queueing at the candidate. This prevents queuing delays from being added to ping response time. This process is shown in 403 a-f and mirrors the sequence in 402 a-f.

The existing nodes (402g, 403g) receive their respective ping responses. Each response is respectively authenticated. The existing nodes individually record the round trip request/response time associated with the candidate node in the public ledger 404 listing these times.

Existing nodes determine when sufficient measurements have been recorded in the public ledger 404, (402h, 403h). Criterion for “sufficient” include but are not limited to recording measurements from all existing nodes, a quorum of existing nodes, a fixed or varying percentage of existing nodes (normally greater than 50%) known to be active within a given time period. These rules themselves may be fixed or variable depending on further conditions, such as network activity, transaction volume, etc.

The existing nodes (402, 403) determine the network space location of the candidate node (402i, 403i), using the ping response data in the public ledger (404d) and appropriate statistical tests as described in the main text above. As all nodes use the same tests on the same dataset their finding of eligibility should be unanimous. The determination may include weightings and measures other than the ping time measurement, given only that the required data for the weighting is available to all nodes through the public ledger, including e.g., the length of time each node has existed on the network, the network space location of each node as determined by the data on the public ledger, the transaction history of nodes or other available factors. Nodes which act against the consensus so determined may be penalized in a variety of ways under normal network operations, including forfeiture of network rewards and ejection from the network.

The existing nodes apply the granularity constraints, limiting constraints and all other constraint conditions (402j, 403j), and determine if the candidate node (401) is eligible to participate in the network (402k, 403k). If so the candidate public key and other network data is added (402m, 403m) to a list of nodes which defines the distributed network, which is also stored on the public ledger 404e. The candidate node (401) is then able to participate in normal network operations (401l, 402n, 403n), including validating the admission of further nodes to the network.

Should the candidate not meet the constraint requirements, the candidate is not added to the network and the existing nodes continue normal operations (402n, 403n).

Normal network operations includes the periodic interrogation of all other nodes by each node, the receipt of responses, the posting of results, and the assessment of admissibility under the participation policy in a manner generally similar to the process outlined above. The periodicity of interrogation may be set at a constant value, such as by the minute, hour, or day as required to determine that nodes remain active and continue to meet requirements, or the interrogation period may be variable according to network or other conditions. Normal network operation may alternatively see nodes requesting revalidation in order to maintain network membership according to a set of rules, which again may see either fixed or variable periodicity, or which may involve other criterion. Ping results are again recorded in the network public ledger.

In all cases the system collectively validates each node's physical location, subject to the same distance constraints that govern network admissibility. Due to network variations, previously admitted nodes may fail the participation policy. This may be handled in many ways, including ignoring the failure, ejecting the node from the network, and suspending the node until the failure condition resolves, or suspending or ejecting the node only if it's newly computed location violates granularity with a previously existing node.

Similarly, improvements in network speed may result in a node moving closer to the inner surface of network space. This network speed change resulting in shorter ping response times relative to at least one existing node may be used to further constrain the addition of subsequent nodes. This may also become a new hard limit for the one existing node's own computed location. Alternatively, the one existing node may be allowed to vary as far as its original network space location without penalty. The participation policy itself can be varied according to network parameters, or over time to govern the admissibility criteria for new nodes. Variations in all parameters may be allowed under a variety of methods as required to suit the needs of the particular network envisioned.

Note that this is a general procedure and many variations on it are possible within the scope of the teachings herein. For example, FIG. 4 shows public key encryption techniques in order to ensure security of transmissions, verifiable node identity, and resistance to adversarial parties which may try to interfere with the process. However it is not strictly necessary to the underlying concept. Similarly, ping de-confliction is not strictly necessary, and can be accomplished by a number of means (e.g., the ALOHA algorithm) but is included as a normally desirable feature of a real world, large scale network. Various consensus methods may be used to maintain the network public ledger, including RAFT, PAXOS, hashed blockchain, and other methods which will be familiar to the skilled practitioner. Various membership tracking methods may be used to determine the required size of consensus, including central maintenance of a list of all nodes, local view methods such as SCAMP, and etc.

Nodes which are disconnected from the network may be required to reapply for admittance, or may have their space reserved for them by virtue of the public key or other identifier stored on the network public ledger. If their space is not reserved it may be allocated to another candidate node during their absence, in which case the disconnected nodes may have their reward rates adjusted through consideration of their time of absence, have their network space preserved against their return, either permanently or according to a schedule or formula. Their network space may be allocated to an incoming candidate node if one arrives. If so they may either not be allowed to rejoin, or may be given priority in reclaiming their space. In this case the usurping node may itself be ejected, or the two nodes may share network space according to a schedule or formula. Other means of handling disconnections are possible, and this description should not be taken as limiting.

In all of the above implementations, normal network operations also see using the network so constructed for any purpose that requires limiting the number of nodes, ensuring their geographic distribution, ensuring other measurable characteristics, or a combination of these, whether such qualities are desired locally or globally. One implementation is as the proof protocol for a cryptocurrency network (Proof of Location), where the scarcity of node locations makes them valuable, and their global distribution makes centralization difficult. In this case any number of consensus and ledger construction and validation techniques may be used in the context of this network, including additional proof protocols, such as Proof of Work or Proof of Stake. This network may issue digitally unique tokens, which may then be exchanged between digitally unique identities on the network. This may optionally include a Turing-complete programming language which can execute arbitrary code, for which the network may charge rates for execution measured in digital tokens, and which may have transactional outcomes to computations (smart contracts). Such rates may be set through an automated market using input from all nodes, or entirely automatically through a mechanism which measures network load as a measure of supply and demand. Additional automated markets may be implemented, using smart contracts and cryptocurrency exchange (smart markets).

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout the description and claims of this specification, singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, ma be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A computer-implemented method to control participation in a distributed network through a consensus of a plurality of existing nodes within the distributed network, the method comprising:
receiving, at one node of the plurality of existing nodes, a request to for a candidate node to join the distributed network;
evaluating, by the one node, a measure of eligibility of the candidate node to join the distributed network using a participation policy, the participation policy requiring the candidate node to comprise one or more physical characteristics to evaluate the measure of eligibility;
determining, by the one node, whether the consensus of the plurality of existing nodes is achieved, wherein the consensus is achieved through integration of the measure of eligibility evaluated by the one node with respective measures of eligibility from other nodes of the plurality of existing nodes according to a consensus model to permit or deny participation to the candidate node; and
communicating with the candidate node following an admission of the candidate node to participate in the distributed network in response to the determination of the nodes.

2. The method as described in claim 1, where the physical characteristics of the candidate node may comprise any one or more of computing speed, memory capacity, network throughput capacity, physical location, network signal response time (ping time), and any other parameter of the candidate node that can be verified by each of the plurality of existing nodes.

3. The method as described in claim 2, wherein one of the physical characteristics of the candidate node comprises a minimum physical distance between the candidate node and each of the plurality of existing nodes.

4. The method as described in claim 2, where the participation policy comprises a requirement that the one or more physical characteristics of the candidate node are unique and discrete from each of the plurality of existing nodes.

5. The method as described in claim 2, where the participation policy comprises a requirement that the physical characteristics of the candidate node are unique and discrete from each of the plurality of existing nodes and all other nodes which have ever existed on the distributed network.

6. The method as described in claim 1, where the participation policy comprises a requirement that the physical characteristics of the candidate node meet conditions of increasing stringency with respect to each of the plurality of existing nodes on the distributed network.

7. The method as described in claim 1, comprising, by the one node and in respect of another node of the plurality of existing nodes:
periodically determining a respective measure of eligibility in respect of the another node to remain within the distributed network in accordance with the participation policy;
providing the respective measure of eligibility for determining by the plurality of existing nodes whether the another node remains within the distributed network according to a consensus achieved among the plurality of existing nodes, each of the plurality of existing nodes reviewing each respective measure of eligibility for the another node according to the consensus model to permit or deny participation within the distributed network.

8. The method as described in claim 1, wherein physical location is one of the physical characteristics in the participation policy.

9. The method as described in claim 1, wherein signal response time is one of the physical characteristics in the participation policy.

10. The method as described in claim 9, wherein the one node measures the signal response time between the one node and the candidate node to determine the measure of eligibility to establish unique locations for each of the plurality of existing nodes in a network space defining the distributed network.

11. The method as described in claim 10, wherein signal response time triangulation between the plurality of existing nodes is used to establish a network space location constraint for application to the candidate node for use as one of the physical characteristics in the participation policy.

12. The method as described in claim 8, wherein the one node measures a signal response time between the one node and the candidate node to verify a physical or network space location of the candidate node which has been established by other means as one of the physical characteristics in the participation policy.

13. The method as described in claim 8, wherein the participation policy requires that each node within the distributed network be distributed with a specified amount of granularity with respect to the one or more physical characteristics of the participation policy, including, optionally, where a granularity specification is allowed to vary either in time, space, or both.

14. A node on a distributed computing network configured to perform a method to control participation in the distributed network through a consensus of a plurality of existing nodes within the distributed network, the node defining a first node and the method comprising:
receiving, at the first node, a request to for a candidate node to join the distributed network;
evaluating, by the first node, a measure of eligibility of the candidate node to join the distributed network using a participation policy, the participation policy requiring the candidate node to comprise one or more physical characteristics to evaluate the measure of eligibility;
determining, by the first node, whether the consensus of the plurality of existing nodes is achieved, wherein the consensus is achieved through integration of the measure of eligibility evaluated by the first node with respective measures of eligibility from other nodes of the plurality of existing nodes according to a consensus model to permit or deny participation to the candidate node; and
communicating with the candidate node following an admission of the candidate node to participate in the distributed network in response to the determination of the nodes.

15. The node as described in claim 14 further configured to perform computing tasks, either alone or together with other nodes of the distributed network.

16. The node as described in claim 15 further configured to determine the validity or correctness of the computing tasks performed by other nodes through the consensus of the plurality of nodes on the distributed network.

17. The node as described in claim 15 configured to perform the computing tasks to receive unique digital tokens created through cryptographic proof-of-work, proof-of-stake, other proof protocol, or other method.

18. The node as described in claim 17 configured to exchange unique digital tokens as between unique identities established on the distributed network.

19. The node as described in claim 18 configured to exchange unique digital tokens for arbitrary transaction settlement.

20. The node as described in claim 18 configured to exchange unique digital tokens for a given amount of computing work.

21. The node as described in claim 20, wherein the unique digital tokens are exchanged for a given amount of computing work according to a network-wide price for the computing work.

22. The node as described in claim 20, wherein the unique digital tokens are exchanged for a given amount of computing work according to an automated market based on user settable prices for computing work.

23. The node as described in claim 14 comprising one or more processors and a storage device coupled thereto, the storage device storing instructions which when executed by the one or more processors configure the node to operate.
